(19) United States
(12) Patent Application Publication
(10) Pub. No.: US 2020/0203991 A1
(43) Pub. Date: Jun. 25, 2020

(54) USER INTERFACE DEVICE AND POWER TRANSMISSION SYSTEM HAVING A USER INTERFACE DEVICE

(71) Applicant: Robert Bosch GmbH, Stuttgart (DE)

(72) Inventors: Martin Gonda, Buehl (DE); Dragan Krupezevic, Stuttgart (DE); Juergen Mack, Goeppingen (DE)

(21) Appl. No.: 16/623,619

(22) PCT Filed: May 28, 2018
(86) PCT No.: PCT/EP2018/063896

§ 371 Date: Dec. 17, 2019

(30) Foreign Application Priority Data
Jun. 20, 2017 (DE) 10 2017 210 223.3

(51) Int. Cl. H02J 50/05; H02J 50/10; H02J 7/00; B25F 5/00

(52) U.S. Cl. CPC H02J 50/05; H02J 50/10; B25F 5/00; H02J 7/00034; H02J 7/0047

(57) ABSTRACT

A user interface device, in particular, for a handheld power tool, including at least one input unit, which is intended for at least inputting at least one mechanically processible and/or processed information item, and/or including at least one output unit, which is intended at least for outputting a mechanically processible and/or processed information item. The user interface device has at least one power transmission unit, which is intended for wirelessly transmitting power of at least a separate energy storage unit and/or for operating a separate, electrically operable device.

### FIELD OF THE INVENTION

The present invention relates to a user interface and power transmission system having a user interface device.

### BACKGROUND INFORMATION

A user interface device has already been proposed, which includes at least one input unit intended for at least inputting at least one mechanically processible and/or processed information item, and/or at least one output unit intended for at least outputting a mechanically processible and/or processed information item.

### SUMMARY OF THE INVENTION

The present invention starts out from a user interface device, which may be for at least one electrically operable device, in particular, for at least one handheld power tool, including at least one input unit that is intended for at least inputting at least one mechanically processible and/or processed information item, and/or including at least one output unit that is intended at least for outputting a mechanically processible and/or processed information item.

It is provided that the user interface device have at least one power transmission unit, which is intended for wireless power transmission, at least for charging a separate energy store and/or for operating a separate electrically operable device.

This advantageously allows a user interface device having improved characteristics with regard to functionality to be provided. In addition, in particular, a number of individual devices, such as separately formed input, output and power transmission devices, may be reduced. Furthermore, an efficiency, in particular, a space efficiency and/or cost efficiency, of the user interface device may be improved in a particularly advantageous manner. Moreover, user comfort may be improved in a further advantageous manner.

A “user interface device” shall be understood to mean, in particular, a device, which is at least part of a user interface that is intended for exchanging at least one mechanically processible and/or processed information item between a user and a processing unit, in particular, for the inputting and/or outputting of a mechanically processible and/or processed information item by/for a user. In particular, the user interface device may form at least a part of, which may be, at least a large part of, and particularly may be, the entire user interface. In particular, “intended” is to be understood as, in particular, specially programmed, configured and/or equipped. That an object is intended for a particular function, is to be understood to mean that, in particular, the object fulfills and/or executes this particular function in at least one application state and/or operating state. In this context, the expression “to at least a large extent” shall be understood to mean, in particular, at least 55%, advantageously, at least 65%, which may be, at least 75%, particularly may be, at least 85%, and particularly advantageously, at least 95%, of a volume and/or of an overall weight. The user interface is, in particular, an input device, an output device, and/or a computer, which includes, in particular, a processing unit, the input device and the output device, such as a laptop, a handheld instrument, a tablet computer, a smartphone, a smart watch, or the like. The electrically operable device may take the form of a handheld power tool. A “handheld power tool” is to be understood as, in particular, a workpiece-processing machine, but advantageously, a drill, a hammer drill and/or percussion hammer, a saw, a planer, a screwdriver, a milling tool, a grinder, an angle grinder, a gardening tool and/or a multifunctional tool. Alternatively, or in addition, the electrically operable device may take the form of, in particular, a laptop, a handheld instrument, a tablet computer, a navigation device, a smartphone, a tablet computer, a smart watch, or the like. An “input unit” is to be understood as, in particular, a unit, which includes at least one input element that is intended for the inputting of at least one mechanically processed and/or mechanically processible information item by a user. In addition, the input unit may include, in particular, at least one further input element, which is intended, for example, for mechanically inputting, in particular, for receiving data. In particular, the input unit may be part of an input device. An “output” unit is to be understood as, in particular, a unit, which includes at least one output element that is intended for outputting the mechanically processed and/or mechanically processible information item for a user. In addition, the output unit may include, in particular, at least one further output element, which is intended, for example, for mechanically outputting, in particular, for transmitting, information. In particular, the output unit may be part of an output device. A “mechanically processed and/or mechanically processible information item” is to be understood as, in particular, an information item, which is processed and/or processible with the aid of at least one processing unit. In particular, it is conceivable for the user interface device, in particular, when it takes the form of a computer, to include the processing unit, which is intended for processing the information item. In addition, it is conceivable for the processing unit to be part of an external unit. An “external unit” is to be understood as, in particular, a unit, which is formed separately from the user interface device, the energy storage unit and/or the electrically operable device. In particular, the external unit takes the form of a computer, namely, in particular, a laptop. Alternatively, external unit 28 may take the form of a PC, a handheld instrument, in particular, a tablet computer, a smartphone, a smart watch, or the like, or the form of a server, a computer network, in particular, a cloud. A “power transmission unit” is to be understood as, in particular, a unit, which includes at least one energy transfer element that is intended for transferring energy, at least, for charging the separate energy storage unit and/or for operating the electrically operable device. “Wireless power transmission” is to be understood as, in particular, inductive and/or capacitive power transmission. In particular, the energy transfer element takes the form of an induction coil and/or a capacitive plate. In particular, the power transmission unit includes at least one power transmission supply unit, which supplies electrical energy. The energy transfer element is connected, in particular, electrically, to the power transmission supply unit. A “separate energy storage unit” is to be understood as, in particular, an energy storage unit, which is formed separately from the user interface device and/or a device including the user interface. The energy storage unit is intended, in particular, for operating the electrically operable device. The energy storage unit is formed, in particular, separately from the electrically operable device. Alternatively, the energy storage unit may be part of the electrically operable device. The energy storage unit includes, in particular, at least one energy storage element, such as at least one storage battery, in particular, a lithium ion battery. The energy storage unit may include a plurality of energy storage elements, which take the form of individual cells of the energy storage unit. The energy storage unit includes a housing, in which the energy storage element and the energy absorption element are situated together. The energy storage unit may form a storage battery pack. To wirelessly transmit power, the energy storage unit and/or the separate, electrically operable device may be coupled, in particular, to the power transmission unit. In addition, the energy storage unit and/or the separate, electrically operable device may be able to be coupled, in particular, to a plurality of power transmission units that may be different. To that end, in particular, the energy storage unit and/or the separate, electrically operable device is intended for wireless, in particular, capacitive and/or inductive, power transmission. The energy storage unit and/or the separate, electrically operable device includes, in particular, at least one energy absorption element, which may be intended for inductive and/or capacitive absorption of electrical energy. In particular, the energy absorption element takes the form of an induction coil and/or a capacitive plate. The energy absorption element is connected, in particular, electrically, to the energy storage element. In particular, the user interface device includes a communications unit, which may be intended for transmission of a mechanically processed and/or processible information item at least with and/or at least between the electrically operable device, the energy storage unit and/or the external unit. The communications unit is intended, particularly may be, for transmitting at least one power transmission information item, which is associated with at least the energy storage unit, the separate, electrically operable device and/or the power transmission unit. A “power transmission information item” is to be understood as, in particular, an information item, which includes at least data of the energy storage unit, of the separate, electrically operable device and/or of the power transmission unit, such as a power transmission state, a power transmission position, a progress of power transmission, an end time of power transmission, an energy store service life, damage to the energy store, or the like. The user interface device includes, in particular, a housing, in which the input unit, the output unit and/or the power transmission unit, as well as, in particular, the communications unit, are positioned together. In particular, the energy storage unit and/or the separate, electrically operable device is situated outside of the housing of the user interface device.

It is further provided that the power transmission unit, the input unit and/or the output unit be formed in one piece with each other at least partially, which may be, at least to a large extent, and particularly may be, completely. This advantageously allows a component efficiency to be improved, since components designated in this manner may be formed in one piece and/or used jointly by different units for different functions, which means that an advantageous functionality may be achieved. Installation space may be reduced further in a particularly advantageous manner. The input unit and the power transmission unit are advantageously formed in one piece with each other at least partially, which may be, at least to a large extent, and particularly may be, completely. In addition, in particular, the output unit and the power transmission unit are advantageously formed in one piece with each other at least partially, which may be, at least to a large extent, and particularly may be, completely. Furthermore, in particular, the input unit and the output unit are formed in one piece with each other at least partially, which may be, at least to a large extent, and particularly may be, completely. Particularly may be, the power transmission unit, the input unit and the output unit are formed in one piece with each other at least partially, may be, at least to a large extent, and particularly may be, completely. That “at least one unit and at least a further unit are formed in one piece with each other at least partially” is to be understood to mean that at least one element of the unit is formed in one piece with at least one further element of the further unit. “In one piece” is to be understood as, in particular, at least integrally connected, for example, by a welding operation, an adhesive bonding operation, an injection molding operation, and/or another operation appearing suitable to one skilled in the art. In one piece is also to be understood as one-part in an advantageous manner. “One-part” is to be understood as, in particular, formed in one piece. This one piece may be made of a single blank, a mass and/or a casting, particularly may be, in an injection molding operation, in particular, a single-component and/or multicomponent injection molding operation. It particularly may be provided for “in one piece” to be understood in an identical manner.

In addition, it is provided that the input unit have at least one input region, which, in at least one operating state, forms at least part of a power transmission region of the power transmission unit. A “power transmission region” is to be understood as, in particular, a region, which the energy storage unit and/or the separate, electrically operable device at least face in a power transmission state, and/or, in particular, which the energy storage unit and/or the separate, electrically operable device abuts in a power transmission state. Furthermore, in particular, an orientation of the power transmission region relative to the energy storage unit and/or of the separate, electrically operable device, is determined by the energy transfer element. It is conceivable for the power output region, in particular, its size, to be adjustable to the coupling of a plurality of, in particular, differently sized energy storage units and/or a plurality of separate, electrically operable devices. The power transmission unit includes, in particular, at least one power transmission surface, which may form the power transmission region. An “input region” is to be understood as, in particular, a region, which is intended for at least the inputting of an information item by a user. In particular, the input region is at least formed by the input element of the input unit at least partially, which may be, at least to a large extent, and particularly may be, completely. In particular, the input element forms an input surface, which is formed, in particular, in one piece with the power transmission surface. In particular, an, in particular, adjustable subregion of the input region, in particular, of the input surface, forms the power transmission region, in particular, the power transmission surface. For at least the subregion of the input region, which forms the power transmission region, an input function is advantageously deactivatable, in particular, in a power transmission state.

The input unit may take the form of, in particular, an optical and/or acoustic input unit, such as a camera, a scanner, a microphone, or the like. In particular, in order to improve user comfort, it is provided that the input unit take the form of a manual input unit. A “manual input unit” is to be understood, in particular, as an input unit, which is intended for manual inputting of information by a user. In particular, the input element takes the form of a touch-sensitive and/or pressure-sensitive input element, and for this, in particular, it is provided, for example, with an inductive and/or capacitive sensor system. The input element may take the form of a touch pad, a touch display, gesture sensor, proximity sensor, a keyboard, or the like, at least partially, which may be, at least to a large extent, and particularly may be, completely.

It is also provided that the input unit be intended for receiving at least a mechanically processible and/or processed information item from the energy storage unit and/or from the separate, electrically operable device. This allows a functionality to be improved further. In particular, the communications unit may be implemented in a simple manner. In addition, further component parts may be eliminated, and installation space may be reduced. The input unit forms, in particular, at least a portion of the communications unit. The input unit includes, in particular, at least one further receiving element. It is conceivable for the receiving element to be formed in one piece with, and in particular, to be identical to, the energy transfer element of the power transmission unit and/or to the input element of the input unit. In particular, with the aid of the energy transfer element in the form of a receiving element, a power transmission information item, such as, in particular, a power transmission state or the like, may be acquired, using a level of the coupling with the energy absorption element of the energy storage unit and/or of the separate, electrically operable device. Furthermore, a power transmission information item, such as, in particular, a power transmission position or the like, may be determined, in particular, with the aid of the input element in the form of a receiving element, using touch and/or pressure applied to the input unit by the energy storage unit and/or the separate, electrically operable device. Alternatively, or in addition, the input unit may be intended for receiving at least one mechanically processible and/or processed information item from the electrically operable device and/or the external unit.

In addition, it is further provided that the output unit have at least one output region, which, in at least one operating state, at least forms at least one power transmission region at least partially, in particular, the above-mentioned power transmission region, of the power transmission unit. This advantageously allows a component efficiency to be improved, since components may certainly be formed in one piece and/or used jointly by different units for different functions, which means that an advantageous functionality may be achieved. Installation space may be reduced further in a particularly advantageous manner. A “task region” is to be understood as, in particular, a region, which is intended at least for outputting an information item for a user. In particular, the output region is at least formed by the output element of the output unit at least partially, which may be, at least to a large extent, and particularly may be, completely. In particular, the output element forms an output surface, which is formed, in particular, in one piece with the power transmission surface. In particular, a subregion of the output region, in particular, of the output surface, forms the power transmission region, in particular, the power transmission surface. An output function of the subregion of the output region, which forms the power transmission region, is advantageously deactivatable, in particular, in a power transmission state. In addition, the output element and the input element are formed, in particular, in one piece. In particular, the output region is identical to the input region.

In particular, the output unit may be configured as a manual and/or acoustic output unit. In particular, in order to improve user comfort, it is provided that the output unit take the form of an optical output unit. In particular, the output element takes the form of an indicator, such as a display, a touch display, or the like. Furthermore, the output unit is, in particular, formed at least partially in one piece with the input unit; the input element and the output element may be formed in one piece with each other.

It is further provided that the output unit be intended for transmitting the mechanically processible and/or processed information item to at least one external unit. This allows a functionality to be improved further. In particular, the communications unit may be implemented in a simple manner. In addition, further component parts may be eliminated, and installation space may be reduced. The output unit forms, in particular, at least a portion of the communications unit. In particular, the output unit is intended for transmitting a power transmission information item. In particular, the output unit includes at least one transmitting element. It is conceivable for the transmitting element to be formed in one piece with, and in particular, to be identical to, the energy transfer element of the power transmission unit and/or to the output element of the output unit. In particular, with the aid of the energy transfer element in the form of a transmitting element, a power transmission information item, such as, in particular, a power transmission state or the like, may be sent with the aid of the energy transfer element, using a level of the coupling with the energy absorption element of the energy storage unit and/or of the separate, electrically operable device. In addition, a power transmission information item, such as a power transmission position or the like, may be sent, in particular, with the aid of the output element in the form of a transmitting element. The output element may be used as an optical transmitting element, in order to transmit data. Furthermore, an embodiment of the transmitting element as a cable interface or cableless transmitting element, such as via Bluetooth, Wi-Fi or the like, is conceivable.

Alternatively, or in addition, the output unit may be intended for transmitting the mechanically processible and/or processed information item to the energy storage unit and/or to the electrically operable device.

In addition, it is provided that the user interface unit have at least one control unit, which is intended for controlling a power transmission state of the power transmission unit, an input state of the input unit, and/or an output state of the output unit as a function of at least one criterion. A functionality may be improved further in an advantageous manner. For example, in particular, incorrect positioning of the energy storage unit and/or of the separate, electrically operable device may be detected in a power transmission state, and/or an intended power transmission position may be indicated. An incorrect input may be prevented in a particularly advantageous manner, via contact of the input unit with the energy storage unit and/or with the separate, electrically operable device. A “power transmission state” is to be understood as, in particular, a state, in which the power transmission unit is intended to execute a power transmission function. An “input state” is to be understood as, in particular, a state, in which the input unit is intended for executing an input function. An “output state” is to be understood as, in particular, a state, in which the output unit is intended for executing an output function. A “control unit” is to be understood as, in particular, a unit having at least one piece of control electronics. “Control electronics” are to be understood as, in particular, a unit including a processor unit and a storage unit, as well as an operating program stored in the storage unit. “Controlling” is to be understood as, in particular, activating and/or deactivating. It is conceivable for the control unit to be intended to deactivate the input function as a function of the criterion in an energy charging state of the power transmission unit, in particular, in the subregion of the input region, which forms the power transmission region. In addition, in particular, as a function of the criterion, the control unit may be intended for deactivating the output function in an energy charging state of the power transmission unit, in the subregion of the indicating region, which forms the power transmission region. Alternatively, it is conceivable for the output function to be capable of being activated by the control unit, in particular, as a function of the criterion in an energy charging state in the subregion of the indicating region, in order, in particular, to output, in particular, to indicate, an intended power transmission position, there, for the energy storage unit and/or the separate, electrically operable device. Furthermore, it is conceivable for the input function to be activatable by the control unit, in the subregion of the input region, as a function of the criterion in an energy charging state, in order to input, detect, and/or receive an actual power transmission position of the energy storage unit and/or of the separate, electrically operable device.

In addition, it is further provided that the user interface device include at least one sensor unit, which has at least one sensor that is intended to detect, as a criterion, a movement of the energy store at least relative to the power transmission unit. The sensor is intended, in particular, for detecting a position, a movement, and/or an approach of the energy storage unit and/or of the separate, electrically operable device relative to the power transmission unit. The measured position, movement and/or approach is intended as the criterion for the activation and/or deactivation by the control unit. It is conceivable for the sensor to be formed by the energy transfer element, the input element and/or the receiving element, and/or for it to be identical to this. In addition, the sensor may be formed by the input element. Furthermore, in particular, a power transmission information item may be provided as a criterion.

In a further aspect of the present invention, a power transmission system, in particular, for a handheld power tool, having at least one user interface device according to one of the preceding embodiments, and having at least one separate energy store that is, in particular, part of the handheld power tool, is provided. In addition, the power transmission system includes at least one external unit, in particular, the external unit mentioned above. It is conceivable for the power transmission system to include a plurality of external units, which are configured, in particular, differently from each other.

In this connection, the user interface device of the present invention and/or the power transmission system of the present invention shall not be limited to the use and specific embodiment described above. In particular, in order to achieve a functionality described here, the user interface device of the present invention and/or the power transmission system of the present invention may have a number of individual elements, component parts and units different from a number mentioned here.

Further advantages are derived from the description of the FIGURES that follows. An exemplary embodiment of the present invention is depicted in the drawing. The drawing, the description, and the embodiments include numerous features in combination. One skilled in the art will necessarily consider the features individually, as well, and unite them to form useful, further combinations.

### BRIEF DESCRIPTION OF THE DRAWING

FIG. 1 shows a schematic representation of a power transmission system having a user interface device.

### DETAILED DESCRIPTION

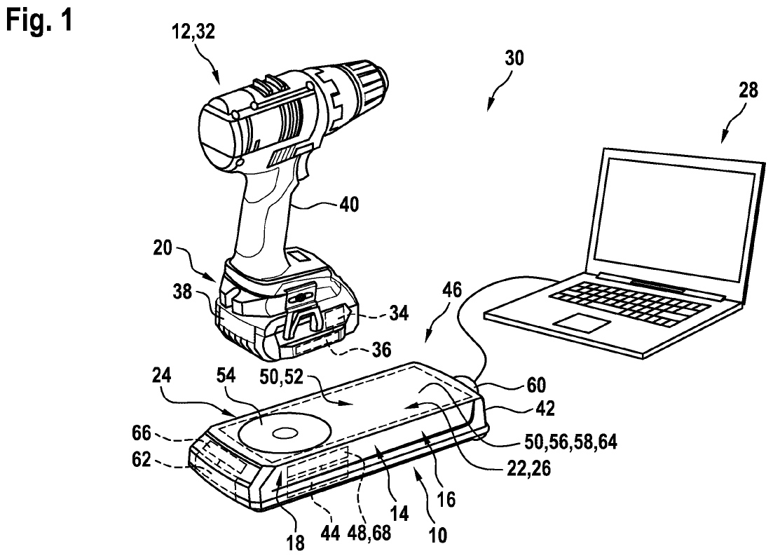

A schematic representation of a power transmission system 30 is shown in FIG. 1. Power transmission system 30 includes at least one electrically operable device 32. In the present case, electrically operable device 32 takes the form of a handheld power tool 12, namely, in particular, a drill. Alternatively, or in addition, electrically operable device 32 may also be formed differently from the present embodiment, in particular, as a different handheld power tool known to one skilled in the art, such as an angle grinder, a hammer drill, a gardening tool, or as a handheld instrument, such as a navigation device, a smartphone, a tablet computer, a smart watch, or the like. In addition, it is conceivable for power transmission system 30 to include a plurality of, in particular, at least two electrically operated devices 32 may be formed differently from each other.

Furthermore, power transmission system 30 includes at least one energy storage unit 20. Energy storage unit 20 is assigned to electrically operable device 32. Energy storage unit 20 is intended for operating electrically operable device 32 electrically. In addition, it is conceivable for energy storage unit 20 to be intended for operating a plurality of electrically operable devices 32 formed, in particular, differently. Alternatively, power transmission system 30 may include a plurality of energy storage units 20, namely, in particular, at least one energy storage unit 20 per electrically operable device 32. Energy storage unit 20 forms a storage battery pack. In the present case, energy storage unit 20 is formed separately from electrically operable device 32. Energy storage unit 20 is connectable, in particular, mechanically and/or electrically, to electrically operable device 32. Energy storage unit 20 has a housing 38. Housing 38 is formed separately from a housing 40 of electrically operable device 32. Alternatively, or in addition, energy storage unit 20 may be part of electrically operable device 32 and, in particular, may be situated in housing 40 of electrically operable device 32.

Energy storage unit 20 includes at least one energy storage element 34. Energy storage element 34 takes the form of a chargeable energy storage element 34, such as a storage battery. In addition, energy storage unit 20 may include a plurality of energy storage elements 34, which form, in particular, individual cells of energy storage unit 20. For wireless power transmission, energy storage unit 20 may be coupled to at least one power transmission unit 18. In addition, energy storage unit 20 may be capable of being coupled to a plurality of different power transmission units 18. To that end, in particular, energy storage unit 20 is intended for wireless, in particular, capacitive and/or inductive power transmission. Energy storage unit 20 includes at least one energy absorption element 36. Energy absorption element 36 is connected electrically to the energy storage element 34. Energy absorption element 36 is intended for wireless, in particular, inductive and/or capacitive, absorption of electrical energy. In the present case, energy absorption element 36 takes the form of an induction coil. Alternatively, energy absorption element 36 could take the form of a capacitive plate.

Power transmission system 30 includes at least one external unit 28. In the present case, external unit 28 takes the form of a computer, namely, in particular, a laptop. It is conceivable for power transmission system 30 to include a plurality of external units 28, which are configured, in particular, differently from each other. Alternatively, external unit 28 may take the form of a PC, a handheld instrument, in particular, a tablet computer, a smartphone, a smart watch, or the like, or of a server, a computer network, in particular, a cloud.

Power transmission unit 30 includes at least one user interface device 10. User interface device 10 may take the form of, at least partially, which may be, at least to a large extent, and particularly may be, completely, a user interface, such as an input device, an output device, and/or a computer, in particular, a laptop, a handheld instrument, a smart phone or the like. In the present case, user interface device 10 constitutes a tablet computer. User interface device 10 includes at least one housing 42. Housing 42 is intended for mounting further units of user interface device 10. In this context, in particular, energy storage unit 20 is formed separately from user interface device 10 and is situated, in particular, outside of housing 42 of user interface device 10.

User interface device 10 includes at least one power transmission unit 18. Power transmission unit 18 is intended for the wireless transmission of power of at least energy storage unit 20. In addition, power transmission unit 18 may be intended for wirelessly transmitting power to a plurality of, in particular, differently formed energy storage units 20. Power transmission unit 18 is situated at least partially, which may be, at least to a large extent, and particularly may be, completely, in housing 42 of user interface device 10. Power transmission unit 18 includes at least one power transmission supply unit 44. Power transmission supply unit 44 provides electrical energy for a charging operation of energy storage unit 20. Power transmission unit 18 may be coupled to at least energy storage unit 20, in order to transfer energy. In addition, power transmission unit 18 may be capable of being coupled to a plurality of different energy storage units 20. To that end, in particular, power transmission unit 18 is intended for wireless, in particular, capacitive and/or inductive, power transmission. Power transmission unit 18 includes at least one energy transfer element 48. Energy transfer element 48 is connected electrically to power transmission supply unit 44. Energy transfer element 48 is intended for wireless, in particular, inductive and/or capacitive, transfer of electrical energy. In at least one power transmission state, energy transfer element 48 of power transmission unit 18 couples to energy absorption element 36 of energy storage unit 20. In the present case, energy transfer element 48 takes the form of an induction coil. Alternatively, energy transfer element 48 may take the form of a capacitive plate.

Power transmission unit 18 includes a power transmission region 24. Power transmission region 24 is a region, which energy storage unit 20 at least faces in one power transmission state, and/or, in particular, which energy storage unit 20 abuts in one power transmission state. In addition, an orientation of power transmission region 24 relative to energy storage unit 20 is determined by energy transfer element 48. Furthermore, power transmission region 24, in particular, its size, may be adjusted to the coupling of a plurality of, in particular, differently sized energy storage units 20. Power transmission unit 18 includes a power transmission surface 54. Power transmission surface 54 forms power transmission region 24.

User interface device 10 includes a communications unit 46. In particular, communications unit 46 is intended for transmission of a mechanically processed and/or processible information item at least with and/or at least between electrically operable device 32, energy storage unit 20 and/or external unit 28. In addition, communications unit 46 is intended for transmitting at least one power transmission information item, which is associated with at least energy storage unit 20 and/or power transmission unit 18. In the present case, the power transmission information item includes at least data of energy storage unit 20 and/or of power transmission unit 18, such as a power transmission state, a power transmission position, a progress of power transmission, an end time of power transmission, an energy store service life, damage to the energy store, or the like.

User interface device 10 includes at least one input unit 14. Input unit 14 is intended at least for inputting at least one mechanically processible and/or processed information item. Input unit 14 is situated at least partially, which may be, at least to a large extent, and particularly may be, completely, in housing 42 of user interface device 10. Input unit 14 includes an input region 22. Input region 22 is a region, in which inputting of the mechanically processible and/or processed information item takes place. Input unit 14 takes the form of a manual input unit.

Input unit 14 includes at least one input element 50. Input element 50 is formed to be touch-sensitive and/or pressure-sensitive, and for this, in particular, it is provided, for example, with an inductive and/or capacitive sensor system. Input unit 14 includes an input surface 64. Input element 50 forms an input surface 64. Input surface 64 defines input region 22. In at least one operating state, input region 22 forms at least a part of power transmission region 24 of power transmission unit 18. In the present case, power transmission unit 18 and input unit 14 are formed at least partially in one piece with each other; in particular, input element 50, which may be, input surface 64, being formed in one piece with power transmission surface 54.

Input unit 14 constitutes at least a part of communications unit 46. In particular, input unit 14 is intended for receiving at least one mechanically processible and/or processed information item, namely, in particular, a power transmission information item. In the present case, input unit 14 is intended for receiving a power transmission information item from energy storage unit 20. To that end, input unit 14 includes at least one receiving element 52. In the present case, receiving element 52 is in one piece with and, in particular, identical to energy transfer element 48 and/or input element 50. For example, with the aid of energy transfer element 48 in the form of receiving element 52, a power transmission information item, such as a power transmission position or the like, may be acquired, using a level of the coupling with energy absorption element 36 of energy storage unit 20. Furthermore, a power transmission information item, such as, in particular, a power transmission position or the like, may be determined, for example, with the aid of input element 50 in the form of a receiving element 52, via touch and/or pressure applied to input unit 14 by energy storage unit 20.

User interface device 10 includes at least one output unit 16. Output unit 16 is intended at least for outputting a mechanically processible and/or processed information item. Output unit 16 is situated at least partially, which may be, at least to a large extent, and particularly may be, completely, in housing 42 of user interface device 10. Output unit 16 includes at least one output region 26. Output region 26 is a region, in which outputting of the mechanically processible and/or processed information item takes place. Output unit 16 takes the form of an optical output unit 16. Output unit 16 includes at least one output element 56. Output element 56 takes the form of an indicator, such as a display. Output unit 16 includes an output surface 58. Output element 56 forms output surface 58. In at least one operating state, output region 26 also forms at least a part of power transmission region 24 of power transmission unit 18. Power transmission region 24 is defined by power transmission surface 54. In the present case, power transmission unit 18 and output unit 16 are formed at least partially in one piece with each other; in particular, output element 56 being formed in one piece with power transmission surface 54.

In addition, output unit 16 and input unit 14 are formed at least partially in one piece with each other. In particular, input element 50 and output element 56 are formed in one piece with each other. Together, output unit 16 and input unit 14 form a touch display.

Output unit 16 forms at least a portion of communications unit 46. To that end, in particular, output unit 16 is intended for transmitting at least one mechanically processible and/or processed information item, namely, in particular, a power transmission information item, to external unit 28. In addition, output unit 16 may be intended for transmitting information to energy storage unit 20 and/or the device 32 to be operated electrically. To that end, input unit 14 includes at least one transmitting element 60. In the present case, transmitting element 60 takes the form of a cable connection. Alternatively, it is conceivable for output unit 16 to be intended for wireless transmission of the information item, such as optical, in particular, infrared, and/or by radio with the aid of Wi-Fi, Bluetooth, or the like.

User interface device 10 further includes at least one control unit 62. Control unit 62 is intended for controlling a power transmission state of power transmission unit 18, an input state of input unit 14, and/or an output state of output unit 16 as a function of at least one criterion. Control unit 62 activates and/or deactivates an input function, output function and/or power transmission function as a function of the criterion. It is conceivable for control unit 62 to deactivate the input function in a power transmission state of power transmission unit 18, in the subregion of input region 22, which forms power transmission region 24. In addition, in a power transmission state of power transmission unit 18, control unit 64 may deactivate the output function in the subregion of the indicating region, which forms power transmission region 24.

Alternatively, it is conceivable for the indicating function to be activatable in the subregion of the indicating region, in order to indicate, there, an intended power transmission position for energy storage unit 20. Furthermore, it is also conceivable for the input function to be activated in the subregion, in order to input an actual power transmission position of energy storage unit 20.

User interface device 10 includes at least one sensor unit 66. Sensor unit 66 includes at least one sensor 68. Sensor 68 is intended for detecting a position of energy storage unit 20 relative to power transmission unit 18. The sensor detects a movement, in particular, an approach of energy storage unit 20 relative to power transmission unit 18. The measured position, movement and/or approach is intended as the criterion for the activation and/or deactivation by control unit 62.

Alternatively, a power transmission information item may be intended as a criterion for the activation and/or deactivation by control unit 62. It is conceivable for sensor 68 to be formed by energy transfer element 48 and/or to be identical to it. In addition, sensor 68 may be formed by input element 50.

1-11. (canceled)

12. A user interface device for a handheld power tool, comprising:
at least one input unit to at least input at least one mechanically processible and/or processed information item, and/or at least one output unit to output a mechanically processible and/or processed information item; and
at least one power transmission unit to wirelessly charge a separate energy store and/or to operate a separate, electrically operable device.

13. The user interface device of claim 12, wherein the power transmission unit, the input unit and/or the output unit are formed at least partially in one piece with each other.

14. The user interface device of claim 12, wherein the input unit includes at least one input region, which, in at least one operating state, forms at least part of a power transmission region of the power transmission unit.

15. The user interface device of claim 12, wherein the input unit includes a manual input unit.

16. The user interface device of claim 12, wherein the input unit is configured to receive at least one mechanically processible and/or processed information item from the energy storage unit.

17. The user interface device of claim 12, wherein the output unit includes at least one output region, which, in at least one operating state, forms at least part of at least a power transmission region of the power transmission unit.

18. The user interface device of claim 12, wherein the output unit includes an optical output unit.

19. The user interface device of claim 12, wherein the output unit is configured to transmit the mechanically processible and/or processed information item to an external unit.

20. The user interface device of claim 12, further comprising:
a control unit, which is configured to control at least one power transmission state of the power transmission unit, at least one input state of the input unit, and/or at least one output state of the output unit, as a function of at least one criterion.

21. The user interface device of claim 20, further comprising:
at least one sensor unit, which includes at least one sensor configured to detect, as a criterion, a movement of the energy storage unit at least relative to the power transmission unit.

22. A power transmission system, for a handheld power tool, comprising:
at least one user interface device, wherein the at least one user interface device includes at least one input unit to at least input at least one mechanically processible and/or processed information item, and/or at least one output unit to output a mechanically processible and/or processed information item, and at least one power transmission unit to wirelessly charge at least one separate energy store unit; and
the at least one separate energy storage unit, which is part of the handheld power tool.
